(19) United States
(12) Patent Application Publication
(10) Pub. No.: US 2013/0128040 A1
(43) Pub. Date: May 23, 2013

(54) SYSTEM AND METHOD FOR ALIGNING CAMERAS

(71) Applicants: Karl A. STOUGH, Elburn, IL (US); George P. WILKIN, Bolingbrook, IL (US); Dean W. CRAIG, Aurora, IL (US)

(72) Inventors: Karl A. STOUGH, Elburn, IL (US); George P. WILKIN, Bolingbrook, IL (US); Dean W. CRAIG, Aurora, IL (US)

(73) Assignee: ALCATEL-LUCENT USA INC., Murray Hill, NJ (US)

(21) Appl. No.: 13/304,289

(22) Filed: Nov. 23, 2011

(51) Int. Cl. H04N 17/00; H04N 7/18

(52) U.S. Cl. 348/143; 348/E17.002; 348/E07.085

(57) ABSTRACT

A method is provided for determining a position where a reference point should be located on a display (24) of an alignment device (20). The reference point corresponds to a target located within a region to be monitored by a camera (10) being aligned with the alignment device (20). The method includes the steps of: determining a minimum Field of View (FoV) such that the camera (10) will view a substantial entirety of the region; determining a first bearing for the camera (10), the first bearing substantially bisecting the FoV; determining a second bearing to the target; determining a different between the first and second bearings; determining a scaling factor (A); and, determining a position where a reference point corresponding to the target should be located on the display (24) of the alignment device (20) based on the scaling factor (A) and the difference between the first and second bearings.

### BACKGROUND

The present inventive subject matter relates generally to the art of camera alignment. Particular but not exclusive relevance is found in connection with the alignment of surveillance cameras, e.g., such as closed-circuit television (CCTV) cameras. Accordingly, the present specification makes specific reference thereto. It is to be appreciated however that aspects of the present inventive subject matter are also equally amenable to other like applications.

Conventionally, installation of a CCTV camera could involve multiple installation crews or personnel possibly making several trips to an installation site, e.g., to install a mounting bracket, set up a network, install the camera itself, align the camera to a desired position, etc. Installation procedures such as this tend to be manpower intensive, and can involve several different individuals or technicians that have to be specially trained for specific tasks.

Accordingly, a new and/or improved system and/or method for aligning cameras is disclosed herein which addresses the above-referenced problem(s) and/or others.

### SUMMARY

This summary is provided to introduce concepts related to the present inventive subject matter. This summary is not intended to identify essential features of the claimed subject matter nor is it intended for use in determining or limiting the scope of the claimed subject matter.

In accordance with one embodiment, a method is provided for determining a position where a reference point should be located on a display of an alignment device. The reference point corresponds to a target located within a region to be monitored by a camera being aligned with the alignment device. The method includes the steps of: determining a minimum Field of View (FoV) such that the camera will view a substantial entirety of the region; determining a first bearing for the camera, the first bearing substantially bisecting the FoV; determining a second bearing to the target; determining a differenced between the first and second bearings; determining a scaling factor; and, determining a position where a reference point corresponding to the target should be located on the display of the alignment device based on the scaling factor and the difference between the first and second bearings.

In accordance with another embodiment, a method is provided for determining a position where a reference point should be located on a display of an alignment device. The reference point corresponds to a target located within a region to be monitored by a camera being aligned with the alignment device. The method includes the steps of: determining a first angle at which the camera should be tilted relative to a reference line such that a direction in which the camera is pointed substantially bisects a Field of View (FoV) which encompasses a substantial entirety of the region; determining a second angle relative to the direction in which the camera is pointed at which a target ray extending from the camera passes through the target; determining a scaling factor; and, determining a position where a reference point corresponding to the target should be located on the display of the alignment device based on the scaling factor and the second angle.

In accordance with yet another embodiment, an alignment device is provided for aiding the alignment of a camera. The alignment device includes: a display, and means for determining a position where a reference point should be located on the display. The reference point corresponds to a target located within a region to be monitored by the camera being aligned with said alignment device. The means being operative to: determine a first coordinate of the reference point position based on a scaling factor and a difference between a first bearing defining a direction in which the camera is pointed and a second bearing pointing to the target; and determine a second coordinate of the reference point position based on the scaling factor and an angle relative to the direction in which the camera is pointed at which a target ray extending from the camera passes through the target.

Numerous advantages and benefits of the inventive subject matter disclosed herein will become apparent to those of ordinary skill in the art upon reading and understanding the present specification.

### BRIEF DESCRIPTION OF THE DRAWING(S)

The following detailed description makes reference to the figures in the accompanying drawings. However, the inventive subject matter disclosed herein may take form in various components and arrangements of components, and in various steps and arrangements of steps. The drawings are only for purposes of illustrating exemplary and/or preferred embodiments and are not to be construed as limiting. Further, it is to be appreciated that the drawings may not be to scale.

FIG. 1 is a diagrammatic illustration showing an exemplary system suitable for practicing aspects of the present inventive subject matter.

FIG. 2 is a flow chart showing exemplary steps for the planning, installation and alignment of a camera in accordance with aspects of the present inventive subject matter.

FIG. 3 is a diagram showing an exemplary layout in a first or horizontal plane for a properly aligned camera, the layout being used to illustrate and/or describe aspects of the present inventive subject matter.

FIG. 4 is a diagram showing the same layout in FIG. 3, this time in a second or vertical plane that is normal to the first or horizontal plane shown in FIG. 3.

### DETAILED DESCRIPTION OF THE EMBODIMENT(S)

For clarity and simplicity, the present specification shall refer to certain structural and/or functional elements, relevant standards and/or protocols, and other components that are commonly known in the art without further detailed explanation as to their configuration or operation except to the extent they have been modified or altered in accordance with and/or to accommodate the preferred embodiment(s) presented herein.

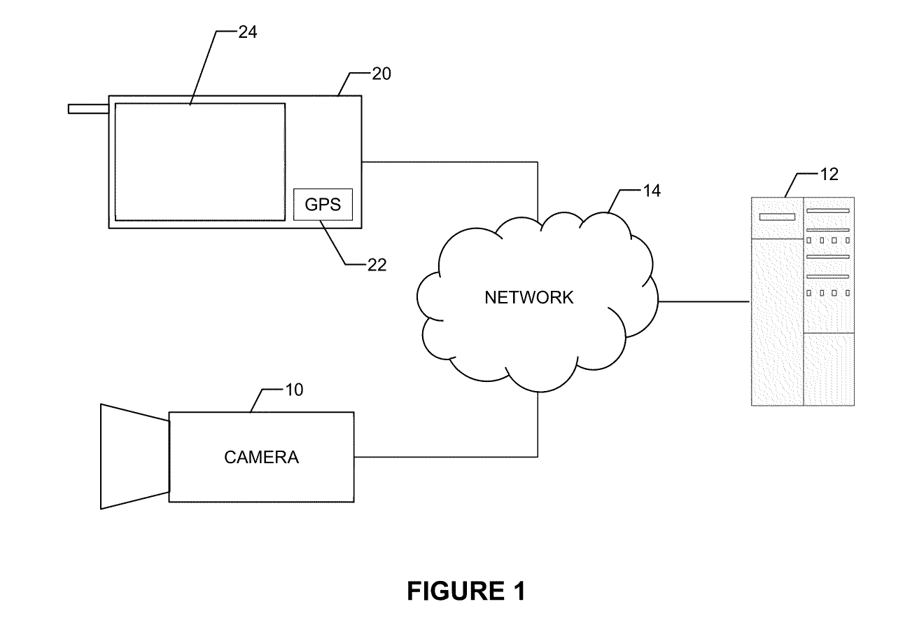

With reference now to FIG. 1, there is illustrated an exemplary system suitable for practicing aspects of the present inventive subject matter. In general, the system aids in and/or provides guidance for the installation, positioning and/or alignment of a camera, e.g., such as a CCTV camera, surveillance camera or the like. As shown, the system includes a camera 10 and a remote server 12 in operative communication with the camera 10, e.g., via a suitable network 14. The system further includes a camera positioning and/or alignment device 20. Suitably, the device 20 is also in operative communication with the server 12, e.g., via the network 14.

In practice, the camera 10 may be a CCTV camera, surveillance camera or the like. For example, the camera 10 may be a digital video camera or IP (Internet Protocol) video camera. However, for some applications, other suitable cameras are also contemplated.

In one suitable embodiment, the camera positioning and/or alignment device 20 may be implemented as a smartphone or another like wireless/mobile telecommunications device which is equipped to communicate with the remote server 12, e.g., via the network 14 or another network. Optionally, the device 20 may be implemented via a wireless/mobile enabled laptop computer, PDA (Personal Digital Assistant) or tablet computer. In any event, the device is optionally equipped with a location determining part 22 and a visual output display 24. For example, the location determining part 22 may include a GPS (Global Positioning System) receiver and/or other suitable equipment which is employed or used in part to calculate or otherwise determine a location or position of the device 20. Suitably, the display 24 may be implemented as a touchscreen or other like interactive display, e.g., such as a touch sensitive LCD (Liquid Crystal Display) or the like.

Optionally, in the case of a smartphone, laptop, PDA, tablet or the like, it is to be appreciated that the camera positioning and/or alignment functions as well as other relevant operations of the device 20 are optionally realized via one or more suitable applications or programs running on and/or supported by the respective device. In particular, the applications or programs may include code or software or other instructions which are formatted and/or stored in a memory or on another medium that is computer and/or machine readable such that when the code, software and/or instructions are executed by a CPU (Central Processing Unit) or other processor of the device 20 the relevant functions, calculations, determinations, processing and/or other operations as described herein are carried out.

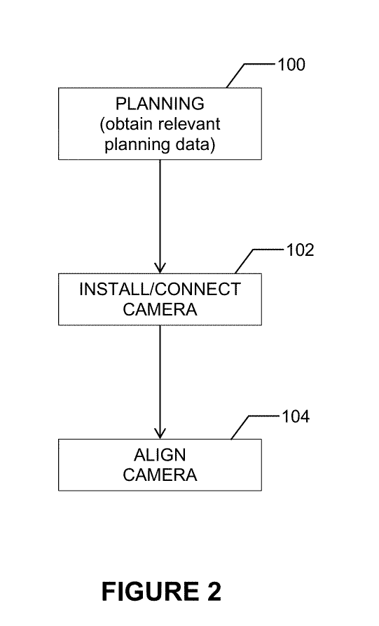

As shown in FIG. 2, setting up the camera 10 may take a series of steps. For example, in a planning step 100, a location for the camera 10 is selected and an area or scene that is to be surveilled by or captured within the view of the camera 10 is mapped and/or otherwise designated. Optionally, in another step 102, the camera 10 may be installed at its designated location and connected to operatively communicate with the remote server 12, e.g., via the network 14 or otherwise. Suitably, in a further step 104, the camera 10 is aligned; that is to say, the pan, tilt and zoom of the camera 10 are adjusted so that the camera 10 is accurately pointed in the appropriate direction to surveil the designate area.

To aid in alignment of the camera 10, a plurality of target positions (e.g., two target positions) are selected at different locations in the designated area to be surveilled. This may be done, for example, during the planning step 100. The selected target positions may correspond with the locations of targets already present in the designated scene to be surveilled or the target positions may be selected to correspond with locations where targets will be placed during the alignment step 104. Optionally, the targets may be infrared (IR) or visible light sources pointed at the camera 10 or other simple markers.

In one suitable embodiment, during the alignment step 104, for example, video or other image data or the like is obtained by the camera 10 and transmitted and/or otherwise communicated to the remote server 12, e.g., via the network 14 or otherwise. In turn, the media (i.e., including video or images captured or otherwise obtained by the camera 10) is forwarded from the server 12 to the alignment device 20, e.g., via the network 14 or otherwise. The video or image or other like media received by the device 20 is then output on the display 24 of the alignment device 20. In this manner, a technician or other individual aligning the camera 10 is able to see on the display 24 what the camera 10 is actually observing or capturing. As can be appreciated, provided the camera 10 is roughly pointed toward the designated area to be surveilled, images of the actual targets within the designated area will appear on the display 24.

Suitably, it is found, calculated and/or otherwise determined where on the display 24 an image of each target should appear when the camera 10 is properly aligned. Optionally, these calculations or determinations are made by the server 12. In one suitable embodiment, these calculations and/or determinations as well as other relevant operations of the server 12 are optionally realized via one or more suitable applications or programs running on and/or supported by the server 12. In particular, the applications or programs may include code or software or other instructions which are formatted and/or stored in a memory or on another medium that is computer and/or machine readable such that when the code, software and/or instructions are executed by a CPU (Central Processing Unit) or other processor of the server 12 the relevant functions, calculations, determinations, processing and/or other operations as described herein are carried out.

In one embodiment, the remote server 12 obtains relevant planning information and/or data (for example during the planning step 100) and from there calculates or otherwise determines the location on the display 24 where the image of each target should appear when the camera 10 is properly aligned. For purposes of the present specification, each so calculate or determined location shall be referred to herein as a reference point. Optionally, if the server calculates and/or determines the locations where the reference points should appear on the display 24, they are in turn communicated to the device 20, e.g., via the network 14 or otherwise. Accordingly, to align the camera 10, the pan, tilt and/or zoom of the camera 10 is manipulated or otherwise adjusted until the images of the actual targets as shown on the display 24 of the alignment device 20 essentially coincide with their respective reference points. Optionally, to aid in visualization of the alignment, icons or other like indications or images representing the reference points may be output on the display 24 at the calculated or otherwise determined locations of the reference points thereon, e.g., simultaneously with output on the display 24 of the actual video or images being obtained from the camera 10.

In one suitable embodiment, the planning data includes coordinate or other defined locations of: the camera 10; the target positions; and a plurality of boundary points defining the designated area to be surveilled. In one suitable embodiment, the alignment device 20 may be placed at each of the foregoing defined locations and the coordinates therefor obtained using the location determining part 22 of the device 20. For example, the device 20 is sequentially placed at each of the foregoing locations and the coordinates for each location are determined by the location determining part 22 of the device 20 while so placed. Having obtained the coordinates or the like for each defined location with the device 20, this data may then be transmitted and/or otherwise communicated to the server 12, e.g., via the network 14 or otherwise. Optionally, each defined location obtained in this manner or otherwise includes or indicates GPS coordinates or the like for the given location, e.g., such as a latitude and a longitude.

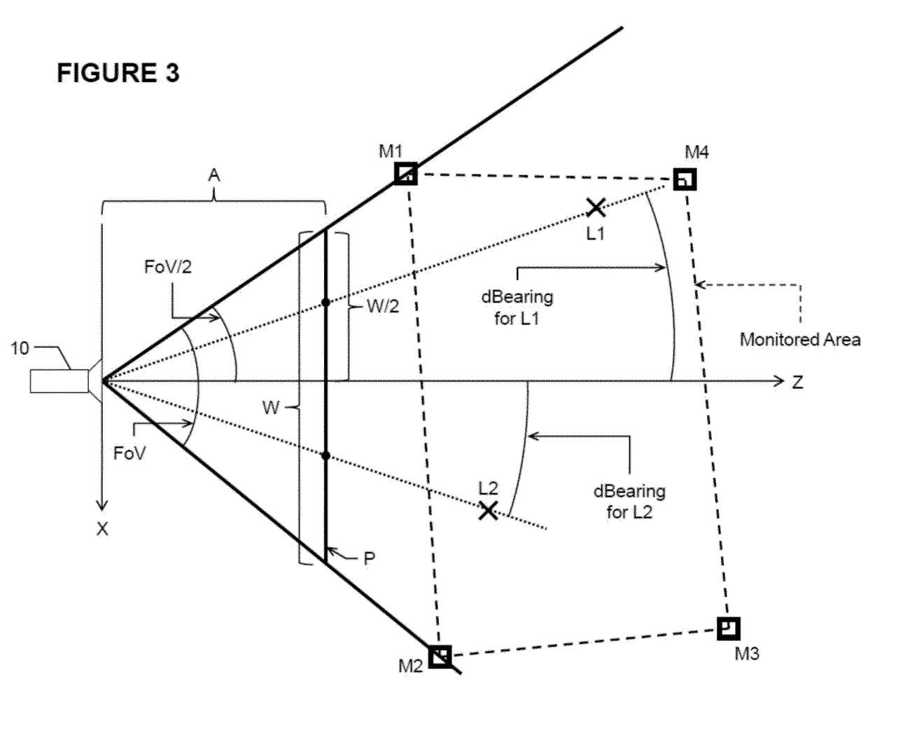

FIG. 3 illustrates an exemplary layout in a horizontal plane (e.g., at ground level) where the camera 10 is properly aligned and its location is taken as the origin of a Cartesian coordinate system defined by an x-axis and a z-axis as shown. In the figure, the locations of the target positions are indicated by L1 and L2, while the locations of the boundary points are indicated by M1, M2, M3 and M4. As shown, the z-axis represents the vanishing line or direction or bearing in which the camera 10 is pointed, while the x-axis is perpendicular or normal thereto. Having obtained the planning data, the distance and bearing (e.g., in the horizontal plane) from the camera's location to each of the other locations (i.e., the locations of each of the target positions and each of the boundary points) is determined. Suitably, each distance and bearing in this case may be calculated using the following formulas:

d=a cos(sin(lat₁)*sin(lat₂)+cos(lat₁)*cos(lat₂)*cos(lon₂−lon₁))*R; and

bearing=a tan 2(sin(lon₂−lon₁)*cos(lat₂),

cos(lat₁)*sin(lat₂)−sin(lat₁)*cos(lat₂)*cos(lon₂−lon₁));

where R represents the radius of the Earth, d represents the distance (e.g., in the horizontal direction) between the camera and a given location, and lat₁, lon₁ and lat₂, lon₂ represent the respective latitudes (lat₂) and longitudes (lon₂) in radians of the camera and the given location. Each bearing value in this case is calculated or otherwise determined as an angle measured from a common reference ray extending from the location of the camera 10 in a given direction to a second ray extending from the location of the camera 10 through the point or target in question. Suitably, the common reference ray may extend from the location of the camera 10 northward and/or define a bearing of zero degrees.

Here, one form of the inverse tangent function a tan 2(y,x) is used to properly format the bearing, where:

y is given by the expression sin(lon₂−lon₁)*cos(lat₂); and

x is given by the expression cos(lat₁)*sin(lat₂)−sin(lat₁)*cos(lat₂)*cos(lon₂−lon₂).

The bearing from the above calculation will range from −π radians to +π radians (−180 degrees to +180 degrees), but it can be converted to a normal 0 to 27 radians (0 degrees to 360 degrees) scale by adding 27 radians (360 degrees) to any negative values.

Having found the bearings for the boundary points (M1 through M4 in the present example), a minimum horizontal Field of View (FoV) may be calculated or otherwise determined therefrom. Suitably, the FoV in this case should not be larger than 180 degrees. In one embodiment, the aforementioned FoV is determined using the two outermost lying boundary points and/or the bearing values therefor, which for purposes herein shall be referred to as the leftmost boundary point bearing or simply leftmost point or leftmost bearing or merely leftmost (i.e., M1 as shown in FIG. 3) and the rightmost boundary point bearing or simply rightmost point or rightmost bearing or merely rightmost (i.e., M2 as shown in FIG. 3). In this case, the FoV is the angle between the bearings of the leftmost and rightmost boundary points. For example, the following pseudocode illustrates one suitable manner in which to check for and/or determine which ones of the boundary point bearings correspond to the leftmost and rightmost.

```
If min(−180 ... +180) + 180 > max(−180 ... +180) then
  // Not spanning the 180 degree south line
  Leftmost = min(−180 ... +180)
  Rightmost = max(−180 ... +180)
Else
  // Spanning 180 degree south line, use set (0 ... 360)
  Leftmost = min (0 ... 360)
  Rightmost = max (0 ... 360)
End if
```

In this example, the set (−180 . . . +180) represents the set of bearings calculated or determined earlier for the defined boundary points, ranging in value from −180 degrees to +180 degrees. Likewise, the set (0 . . . 360) corresponds to the non-negative bearings defined as follows.

In the case where the aforementioned FoV spans a ray extending from the location of the camera 10 through a point having a bearing of 180 degrees (e.g., directly south), then the set (0 . . . 360) containing the positive equivalents of the bearings for the boundary points can be used to find the appropriate FoV. For example, the following pseudocode shows how the set (0 . . . 360) may be found.

```
// Finding the set (0 ... 360)
// n = number of boundary points (e.g., in the present example there are 4)
For i = 1 to n
  If (−180 ... +180) [i] < 0 then
    // If negative, convert to positive
    (0 ... 360) [i] = (−180 ... +180) [i] + 360
  Else
    // Otherwise, leave alone
    (0 ... 360) [i] = (−180 ... +180) [i]
  End if
End loop
```

In either case, the minimum horizontal FoV can be calculated as:

FoV=Rightmost Boundary Point Bearing−Leftmost Boundary Point Bearing.

The vanishing line bearing is then simply the bisection of the rightmost boundary point bearing and the leftmost boundary point bearing. For example, the vanish line bearing (i.e., the bearing at which a properly aligned camera 10 is pointed) may be calculated as or given by:

Vanishing Line Bearing=Leftmost Boundary Point Bearing+(FoV/2).

In an alternate embodiment, the minimum horizontal FoV and/or the vanishing line bearing may simply be specified and/or defined, e.g., in and/or along with the planning data.

In one exemplary embodiment, having determined, found or otherwise specified the minimum horizontal FoV, this value may be used to calculate and/or otherwise determine a scaling factor A. Suitably, the z-axis is now defined by and coincident with the vanishing line and the line perpendicular to the z-axis (through the location of the camera 10 as shown in FIG. 3) is taken as the x-axis. In practice, the x-axis may be parallel to and/or represent a horizontal axis or direction or component on the display 24 of the device 20. In turn, the bearings of the targets along with the scaling factor A may suitably be used to calculate and/or otherwise determine a horizontal position of the references points on the display 24.

Suitably, dBearing is calculated or otherwise determined for each target, where dBearing is the angle between the vanishing line and the bearing to the respective target. For example, dBearing may be calculate or determined as follows:

dBearing=Target Bearing−Vanishing Line Bearing.

In one suitable embodiment, the scaling factor A is calculated, found or otherwise determined to scale a horizontal width of the display 24 to a single or one unit. For example, this allows for cameras with various different resolutions to be used with only one common server side calculation. Essentially, the scaling factor A is the distance (in the z-axis direction) from the camera 10 to where a plane P representing the display 24 is located, the plane P being normal to the vanishing line or z-axis. In this case, at the distance A, the width W as represented in the plane P extends across the entire FoV (i.e., from the left most boundary point bearing to the rightmost boundary point bearing).

Accordingly, given a single unit width (i.e., W=1), the scaling factor A may be found or determined, e.g., using the equation:

A=W/(2*tan(FoV/2));

where the minimum horizontal FoV is in radians.

Using the scaling factor A, each target position is scaled to be A units away from the camera 10 in the z-axis direction. In essence, the target positions are projected along their respective bearings onto the plane P. The resulting x-axis component of each projection represents the horizontal position Pₓ of the corresponding reference point on the display 24 for the given target. Suitably, Pₓ may be found, calculated and/or otherwise determined for each reference point (corresponding to it respective target) using the equation:

Pₓ=W/2+A*tan(dBearing).

Notably, the horizontal positions Pₓ of the reference points on the display 24 are not relative to the vanishing line or the center of the display 24. This is accomplished adding half the width (i.e., W/2) to the expression A*tan(dBearing), which expression otherwise gives a positive or negative distance from the z-axis for the x-axis component of a given target's projection on the plane P along its bearing. Therefore, a first or left edge of the display 24 will represent and/or correspond to a horizontal position of zero, the center of the display 24 (corresponding to the vanishing point line) will represent and/or correspond to a horizontal position of 0.5, and the opposing second or right edge of the display will represent and/or correspond to a horizontal position of 1.0 (given the width W is 1.0). In this case then, the horizontal positions Pₓ of the reference points may lie anywhere between zero and one.

In one suitable embodiment, the horizontal positions Pₓ of the reference points on the display 24 aid in adjusting and/or setting the pan and zoom of the camera 10. To aid in adjusting and/or setting the tilt of the camera 10, the vertical positions P_{y} of each of the reference points on the display 24 may also be found, calculated and/or otherwise determined. Accordingly, the position of each reference point on the display 24 can be defined by a pair of coordinates (Pₓ, P_{y}). For example, the x-coordinate defines a position of the reference point along a first or horizontal direction across the display 24 and the y-coordinate defines a position of the reference point along a second or vertical direction across the display 24, wherein the first or horizontal direction and the second or vertical direction are mutually perpendicular to one another. Suitably, insomuch as the vertical positions P_{y} are not used to adjust or set the zoom of the camera 10, they may continue to be defined relative to a center of the display 24 instead of an edge. For example, this may be done so that cameras with different aspect ratios can be used with only one common set of server side calculations being done for the vertical positions. Accordingly, in one suitable embodiment, the vertical positions P_{y} are scaled to the display 24 of the device 20 using the same scaling factor A as was used in connection with calculating or determining the horizontal positions P.

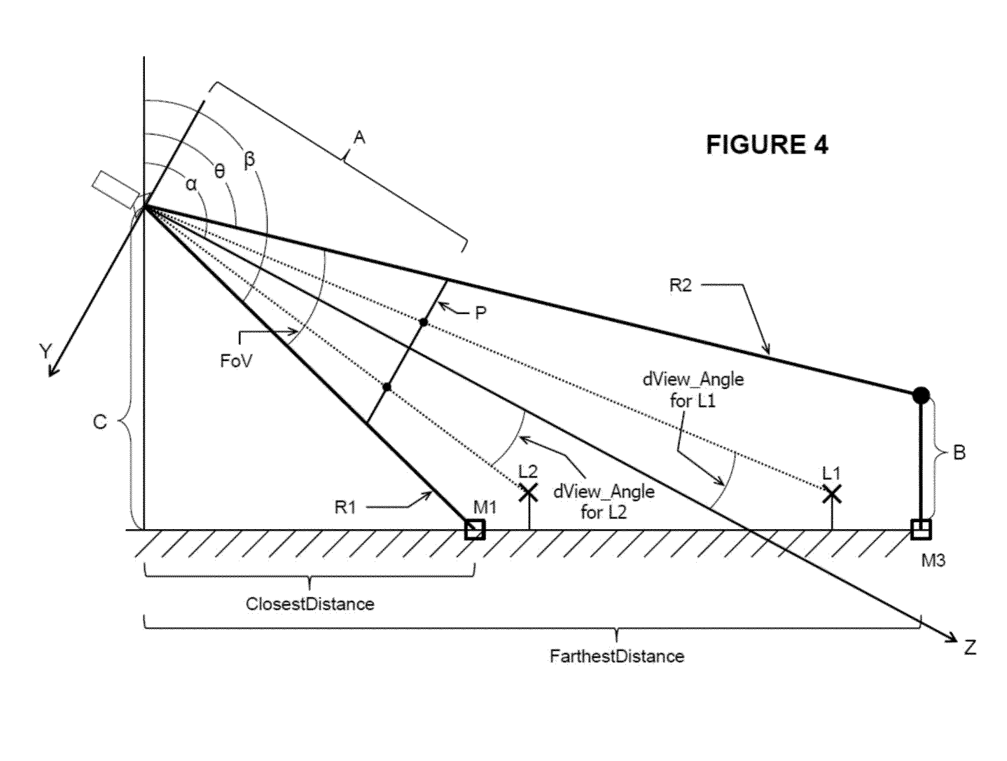

With reference now to FIG. 4, there is illustrated the layout from FIG. 3. This time the layout is shown in a vertical plane. As shown, the camera 10 is properly aligned and its location is taken as the origin of a Cartesian coordinate system defined by a z-axis and a y-axis. In the figure, the locations of the target positions are indicated by the same references as in FIG. 3, as are the boundary points.

In FIG. 4, for simplicity, only boundary points M1 and M3 are shown, insomuch as out of all the defined boundary points these ones are the closest and farthest boundary points relative to the camera 10 and as such they are the ones used in this case (i.e., to calculate or otherwise determine P_{y} for the reference points). In particular, M1 is the boundary point closest to the camera 10 and M3 is the boundary point farthest from the camera 10 in this example. Suitably, the closest and farthest boundary points may be found using the previously calculated and/or otherwise determined horizontal and/or ground-level distances to each of the boundary points. For purposes herein, the horizontal distance to the closest boundary point shall be termed the ClosestDistance and the horizontal distance to the farthest boundary point shall be termed the FarthestDistance.

In the illustrated layout, the camera 10 is mounted or installed at a height C above ground level. Again, the z-axis represents the vanishing line or direction in which the camera 10 is pointed (in this case tilted downward by an angle α in the vertical plane), while the y-axis is perpendicular or normal thereto.

Suitably, the appropriate tilt angle α is found, calculate and/or otherwise determined for the camera 10. To find a, a vertical FoV may be defined as the angle between a first ray R1 that extends from the camera 10 through the closest boundary point (M1 in this example) and a second ray R2 that extends from the camera 10 through a point at a height B above the farthest boundary point (M3 in this example). Accordingly, the first ray R1 will have a first view angle β and the second ray R2 will have a second view angle θ. As shown, the aforementioned tilt and view angles are suitably measured or referenced from a common vertical line, e.g., such that a horizontal line or ray would be at an angle of 90 degrees (π/2 radians) with respect thereto. The appropriate tilt angle α aligns the vanishing line or z-axis so that it bisects the vertical FoV defined between R1 and R2. In one exemplary embodiment, the tilt angle α (in radians) may be found, calculate and/or otherwise determined using the following equation:

α=(β+θ)/2.

Suitably, the view angles β and θ (in radians) may be found, calculated and/or otherwise determined using the following equations:

β=π−arctan(ClosestDistance/C); and

θ=π−arctan(FarthestDistance/(C−B)).

In practice, B and C are generally non-negative values and may be specified in and/or along with the planning data. Suitably, B is chosen so that the targets (at whatever height they are located) reside within the vertical FoV defined between R1 and R2. Optionally, B may have some default value, e.g., such as 2 meters (m). Typically, the tilt angle α may be between 90 degrees (π/2 radians) and 120 degrees (2π/3 radians) and it represents how far down the camera 10 is pointed.

Accordingly, having found, calculate and/or otherwise determined the appropriate tilt angle to vertically align the vanishing line or z-axis properly, vertical positions P_{y} of the reference points on the display 24 (corresponding to each target) may be found, calculate and/or otherwise determined in a fashion similar to Pₓ. In essence, the target positions are projected onto the plane P (at a distance A from the camera 10 along the z-axis) along rays extending from the camera 10 to the respective target. Again, the plane P is generally normal to the z-axis and may represent the display 24 of the device 20. The resulting y-axis component of each projection represents the vertical position P_{y} of the corresponding reference point on the display 24 for the given target. Suitably, P_{y} may be found, calculated and/or otherwise determined for each reference point (corresponding to its respective target) using the equation:

P_{y}=A*tan(dView_Angle).

where A is the same scaling factor previously used in connection with determining Pₓ, and dView_Angle is the angle to the ray extending from the camera 10 through the respective target as measured or referenced from the vanishing line or z-axis. In this case, P_{y} represents a vertical offset of the reference point from a vertical center of the display 24.

In one suitable embodiment, any one or all of the foregoing calculations and/or determinations (for both the horizontal and vertical components) may be made by the server 12 and the results forwarded to the device 20. Alternately, one or more or all of the foregoing calculations and/or determinations may be made by the device 20 itself.

In any event, it is to be appreciated that in connection with the particular exemplary embodiment(s) presented herein certain structural and/or function features are described as being incorporated in defined elements and/or components. However, it is contemplated that these features may, to the same or similar benefit, also likewise be incorporated in other elements and/or components where appropriate. It is also to be appreciated that different aspects of the exemplary embodiments may be selectively employed as appropriate to achieve other alternate embodiments suited for desired applications, the other alternate embodiments thereby realizing the respective advantages of the aspects incorporated therein.

It is also to be appreciated that particular elements or components described herein may have their functionality suitably implemented via hardware, software, firmware or a combination thereof. Additionally, it is to be appreciated that certain elements described herein as incorporated together may under suitable circumstances be stand-alone elements or otherwise divided. Similarly, a plurality of particular functions described as being carried out by one particular element may be carried out by a plurality of distinct elements acting independently to carry out individual functions, or certain individual functions may be split-up and carried out by a plurality of distinct elements acting in concert. Alternately, some elements or components otherwise described and/or shown herein as distinct from one another may be physically or functionally combined where appropriate.

In short, the present specification has been set forth with reference to preferred embodiments. Obviously, modifications and alterations will occur to others upon reading and understanding the present specification. It is intended that the invention be construed as including all such modifications and alterations insofar as they come within the scope of the appended claims or the equivalents thereof.

What is claimed is:

1. A method for determining a position where a reference point should be located on a display of an alignment device, said reference point corresponding to a target located within a region to be monitored by a camera being aligned with said alignment device, said method comprising the steps of:
determining a minimum Field of View (FoV) such that the camera will view a substantial entirety of the region;
determining a first bearing for the camera, said first bearing substantially bisecting the FoV;
determining a second bearing to the target;
determining a difference between the first and second bearings;
determining a scaling factor; and
determining a position where a reference point corresponding to the target should be located on the display of the alignment device based on the scaling factor and the difference between the first and second bearings.

2. The method of claim 1, said method further comprising:
designating the region to be monitored by the camera with a plurality of boundary points defining a periphery of the region.

3. The method of claim 2, wherein determining the FoV comprises:
determining a third bearing to a first outermost boundary point; and
determining a fourth bearing to a second outermost boundary point.

4. The method of claim 3, wherein said FoV is determined as a difference between the bearings to the third and fourth boundary points.

5. The method of claim 4, wherein the first bearing is determined by adding a half of the FoV to the third bearing.

6. The method of claim 1, wherein the scaling factor is substantially equal to a distance from the camera in a direction of the first bearing at which a plane substantially normal to the first bearing is located, such that when the target is projected along the second bearing onto the plane, a location of the projection on the plane is representative of the position where the reference point corresponding to the target should be located on the display of the alignment device.

7. A system for executing the method of claim 1, the system comprising said alignment device.

8. The system of claim 7, said system further comprising a remote server in operative communication with said alignment device, said remote server performing one or more of said steps and communicating a result therefrom to said alignment device.

9. The system of claim 8, wherein the alignment device indicates on its display the determined position of the reference point.

10. A method for determining a position where a reference point should be located on a display of an alignment device, said reference point corresponding to a target located within a region to be monitored by a camera being aligned with said alignment device, said method comprising the steps of:
determining a first angle at which the camera should be tilted relative to a reference line such that a direction in which the camera is pointed substantially bisects a Field of View (FoV) which encompasses a substantial entirety of the region;
determining a second angle relative to the direction in which the camera is pointed at which a target ray extending from the camera passes through the target;
determining a scaling factor; and
determining a position where a reference point corresponding to the target should be located on the display of the alignment device based on the scaling factor and the second angle.

11. The method of claim 10, said method further comprising:
designating the region to be monitored by the camera with a plurality of boundary points defining a periphery of the region.

12. The method of claim 11, wherein determining the first angle comprises:
determining a third angle relative to the reference line at which a first ray extending from the camera passes through a boundary point closest to the camera; and
determining a fourth angle relative to the reference line at which a second ray extending from the camera passes through a point at some distance B away from the boundary point farthest from the camera, the distance B being given relative to a reference level.

13. The method of claim 12, wherein:
determining the third angle comprises determining a first lateral distance from the camera to the boundary point closest to the camera, said third angle being determined based on said first lateral distance; and
determining the fourth angle comprises determining a second lateral distance from the camera to the boundary point farthest from the camera, said fourth angle being determined based on said second lateral distance.

14. The method of claim 13, wherein the camera is located at a distance C away from the reference level, and the third angle is determined further based on the distance C and the fourth angle is determined further based on a difference between the distances C and B.

15. The method of claim 14, wherein the reverence level is ground level and the distances B and C are heights above ground level.

16. The method of claim 12, wherein the first angle is determined from the third and fourth angles.

17. The method of claim 16, wherein the first angle is a half of a sum of the third and fourth angles.

18. The method of claim 10, wherein the scaling factor is substantially equal to a distance from the camera in the direction the camera is pointed at which a plane substantially normal to the direction in which the camera is pointed is located, such that when the target is projected along the target ray onto the plane, a location of the projection on the plane is representative of the position where the reference point corresponding to the target should be located on the display of the alignment device.

19. The method of claim 10, wherein the determined position of the reference point is relative to a center of the display of the alignment device.

20. An alignment device for aiding the alignment of a camera, said alignment device comprising:
a display, and
means for determining a position where a reference point should be located on the display, said reference point corresponding to a target located within a region to be monitored by the camera being aligned with said alignment device; said means being operative to:
determine a first coordinate of the reference point position based on a scaling factor and a difference between a first bearing defining a direction in which the camera is pointed and a second bearing pointing to the target; and
determine a second coordinate of the reference point position based on the scaling factor and an angle relative to the direction in which the camera is pointed at which a target ray extending from the camera passes through the target.
